(19) United States
(12) Patent Application Publication
(10) Pub. No.: US 2019/0114339 A1
(43) Pub. Date: Apr. 18, 2019

(54) IDENTIFYING PATTERNS WITHIN A SET OF EVENTS THAT INCLUDES TIME SERIES DATA

(71) Applicant: Microsoft Technology Licensing, LLC, Redmond, WA (US)

(72) Inventors: Alexandre Igorevich MINEEV, Kenmore, WA (US); Dmitry DENISOV, Bellevue, WA (US); Om Prakash RAVI, Sammamish, WA (US); Karthik SUBRAMANIAN, Bellevue, WA (US)

(21) Appl. No.: 15/786,300

(22) Filed: Oct. 17, 2017

(51) Int. Cl. G06F 17/30; G06F 9/54

(52) U.S. Cl. CPC G06F 17/30371; G06F 17/3053; G06F 9/542

(57) ABSTRACT

A method for facilitating access to information contained within stored events may include receiving a request to provide information about a set of events. The set of events may correspond to time series data from a plurality of devices. The method may also include identifying patterns within the set of events in response to the request. Identifying the patterns within the set of events may include performing basket analysis. The method may also include selecting a subset of the patterns based at least partially on percentage of occurrence within the set of events and pattern similarity.

### CROSS-REFERENCE TO RELATED APPLICATIONS

N/A

### BACKGROUND

Time series data is used in a wide variety of industries for many different purposes. For example, the growth of low-cost and reliable sensor technology has led to the spread of data collection across all sorts of monitored devices, including machinery, cellular phones, engines, vehicles, turbines, appliances, medical telemetry, industrial process plants, and so forth. This sensor data is time series data because it takes the shape of a value or set of values with a corresponding timestamp, or temporal ordering. As another example, modern electronic devices (such as personal computers, smartphones, tablets, and other personal electronic devices) allow significant amounts of data to be captured, often as time series data. This data may include operational data, logs, journals, or the like.

A time series produced by an entity provides information about the states and behavior of that entity. The time series produced by various entities may be analyzed in order to learn and understand more about those entities. By analyzing time series data, entities may be compared to each other and to themselves across time.

Analyzing time series data, however, has proven challenging. This is particularly true for time series data corresponding to a large number of different time series. For example, if time series data is collected from thousands of different devices (such that there are thousands of different time series), the amount of data involved can make it difficult to perform any type of meaningful analysis on that data. Also, the storage mechanisms used for time series data are typically not designed for the convenience of users who are unskilled in the use of database systems.

### SUMMARY

A method for facilitating access to information contained within stored events is disclosed. The method may include receiving a request to provide information about a set of events. The set of events may correspond to time series data from a plurality of devices. The method may also include identifying patterns within the set of events in response to the request. Identifying the patterns within the set of events may include performing basket analysis. The method may also include selecting a subset of the patterns based at least partially on percentage of occurrence within the set of events and pattern similarity.

Each pattern may include a property or a combination of properties. Each pattern may be associated with the percentage of occurrence of the property or the combination of properties within the set of events. In some embodiments, each pattern may include a predicate that represents the pattern as a logical expression.

The method may also include sampling the set of events. The patterns may be identified within a sampled set of events.

Selecting the subset of the patterns may include removing duplicate patterns. Selecting the subset of the patterns may also include assigning a similarity score to each pair of patterns.

The patterns may be automatically identified within the set of events in response to the request. In addition, the subset of the patterns may be automatically selected in response to the request.

The request may be received from a client, and the method may additionally include sending the subset of the patterns to the client. Alternatively, the request may be received via user input, and the method may additionally include displaying the subset of the patterns.

A computer system for facilitating access to information contained within stored events is also disclosed. The computer may include one or more processors and memory comprising instructions that are executable by the one or more processors to perform certain operations. The operations may include receiving a request to provide information about a set of events. The set of events may correspond to time series data from a plurality of devices. The operations may also include identifying patterns within the set of events in response to the request. Identifying the patterns within the set of events may include performing basket analysis. The operations may also include selecting a subset of the patterns based at least partially on percentage of occurrence within the set of events and pattern similarity.

Another method for facilitating access to information contained within stored events is also disclosed. The method may include receiving a request from a client to provide information about a set of events. The set of events may correspond to time series data from a plurality of sources. The method may also include sampling the set of events, thereby producing a sampled set of events. The method may also include identifying patterns within the sampled set of events. A subset of the patterns may be selected based at least partially on percentage of occurrence within the set of events and pattern similarity. The subset of the patterns may be sent to the client.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

Additional features and advantages of implementations of the disclosure will be set forth in the description that follows, and in part will be apparent from the description, or may be learned by the practice of the teachings herein. The features and advantages of such implementations may be realized and obtained by means of the instruments and combinations particularly pointed out in the appended claims. These and other features will become more fully apparent from the following description and appended claims, or may be learned by the practice of such implementations as set forth hereinafter.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, similar reference numbers have been used for similar features in the various embodiments. Unless indicated otherwise, these similar features may have the same or similar attributes and serve the same or similar functions. Understanding that the drawings depict some examples of embodiments, the embodiments will be described and explained with additional specificity and detail through the use of the accompanying drawings in which:

FIG. 1 illustrates a system in which aspects of the present disclosure may be utilized.

FIG. 2 illustrates an example of a table that may be created to store events received from devices.

FIG. 3A illustrates an example of a user interface screen that a data management service may display to a user in response to the user accessing a set of events.

FIG. 3B illustrates a user interface screen that may be displayed in response to the user's selection of a particular timeframe.

FIG. 3C illustrates a user interface screen that may be displayed in response to user input that includes an instruction to identify patterns.

FIG. 4 illustrates an example showing how a data management service may facilitate access to information contained within large numbers of stored events.

FIG. 5 is a flow diagram that illustrates an example of a method for facilitating access to information contained within stored events.

FIG. 6 is a flow diagram that illustrates another example of a method for facilitating access to information contained within stored events.

FIG. 7 is a flow diagram that illustrates another example of a method for facilitating access to information contained within stored events.

FIG. 8 illustrates an example of a method showing how a subset of identified patterns may be selected.

FIG. 9 illustrates characteristics of patterns in accordance with some embodiments.

FIG. 10 illustrates certain components that may be included within a computer system.

### DETAILED DESCRIPTION

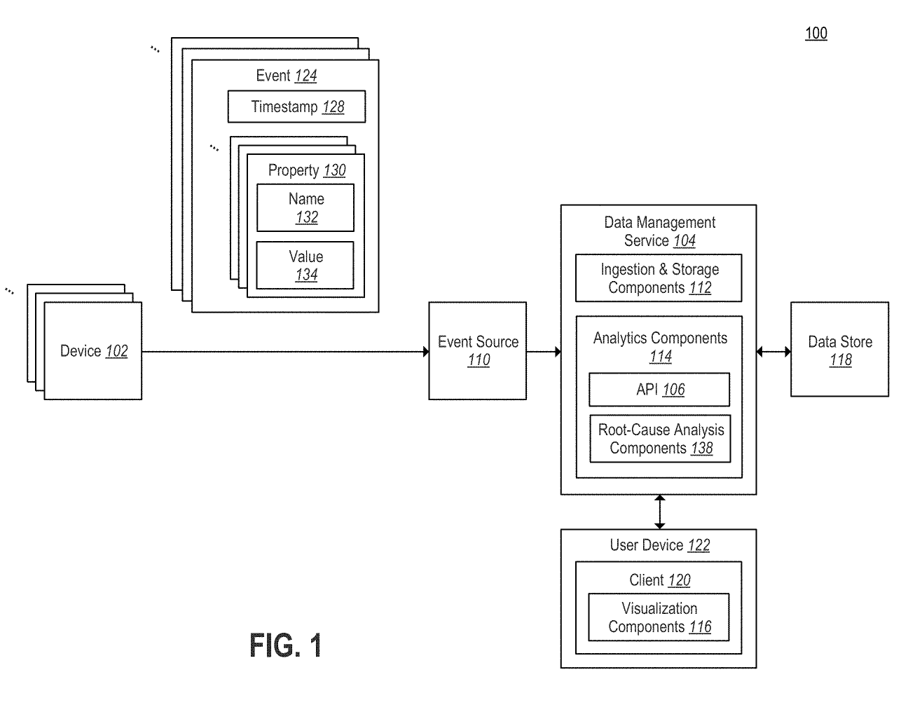

FIG. 1 illustrates a system 100 in which aspects of the present disclosure may be utilized. The system 100 may include a plurality of devices 102 that output time series data. There are many different types of devices 102 from which time series data may be collected or generated. Some examples include sensors, industrial assets, Internet of Things (IoT) devices, consumer electronic devices, mobile devices, mobile apps, web servers, application servers, databases, firewalls, routers, operating systems, and software applications that execute on computer systems.

Some devices 102 may output time series data on a periodic basis. For example, sensors may produce telemetry data every few minutes. Alternatively, time series data may be output in response to particular actions, which may not necessarily occur periodically. For example, mobile apps may capture and report data in response to particular actions taken by customers.

The data output by a particular device 102 may be structured as a stream of events 124. An event 124 may include a timestamp 128. The timestamp 128 corresponding to a particular event 124 may identify the date and time at which the event 124 was generated. An event 124 may also include one or more name-value pairs. Each name-value pair may correspond to a property 130 of the event 124. Thus, a property 130 may include a name 132 and a value 134.

Devices 102 may send streams of events 124 to an event source 110. A data management service (DMS) 104 may read the events 124 from the event source 110. In some embodiments, the DMS 104 may receive events 124 in JavaScript Object Notation (JSON) format. Alternatively, events 124 may be received in a different format, such as the comma separated values (CSV) format. The following is an example of an event 124 in JSON format:

{
“id”:“EH123”,
“timestamp”:“2016-01-08T07:03:00Z”,
“data”:{

“type”:“pressure”,
“units”:“psi”,
“measurement”:108.09

}
}

In this example, the identifier “EH123” identifies the event source 110. The timestamp 128 is 2016-01-08T07:03:00Z (i.e., 7:03 a.m. on Jan. 8, 2016). There are three properties 130: a first property 130 having the name 132 equal to “type” and the value 134 equal to “pressure”, a second property 130 having the name 132 equal to “units” and the value 134 equal to “psi”, and a third property 130 having the name 132 equal to “measurement” and the value 134 equal to the number 108.09.

The DMS 104 may include components for processing the events 124. For example, the DMS 104 may include ingestion and storage components 112 and analytics components 114. The ingestion and storage components 112 may be configured to receive and process large numbers of events 124 (e.g., millions of events 124 per second) from one or more event sources 110. These events 124 may be stored in a data store 118. The analytics components 114 may make various aspects of the events 124 available for users to query via an application programming interface (API) 106.

Communication between the event source(s) 110 and the DMS 104 may occur via one or more computer networks. In some embodiments, the DMS 104 may be implemented as a cloud computing service, and communication between the event source(s) 110 and the DMS 104 may occur via the Internet. Alternatively, the DMS 104 may be implemented as another type of application other than a cloud computing service, and communication between the event source(s) 110 and the DMS 104 may not necessarily require access to the Internet. For example, communication between the event source(s) 110 and the DMS 104 may occur via a local area network (LAN) or wireless LAN. Alternatively still, the event source(s) 110 and the DMS 104 may exist on the same computing device. For example, the DMS 104 may be implemented as a log-processing system that runs on a particular computing device and collects logs produced by an operating system of the computing device.

Users may access information about particular events 124 via a client 120 running on a user device 122, such as a personal computer, laptop computer, mobile device, or the like. The client 120 may be a web browser that accesses the DMS 104 via the Internet. Alternatively, the client 120 may be another type of software application other than a web browser. The client 120 may communicate with the API 106 in order to make queries with respect to the events 124. The client 120 may include visualization components 116 that provide visual representations of various aspects of the events 124 based on queries made via the API 106.

Events 124 stored by the DMS 104 may be partitioned into one or more environments. Different environments may correspond to different users. Under some circumstances, a single user may create multiple environments in order to keep unrelated events 124 separate from one another. For example, a user may create different environments for different sites where devices 102 are located (e.g., different factories).

There are many ways in which the events 124 that the DMS 104 receives from event sources 110 may be analyzed and used. For example, a human operator may use a client 120 running on a user device 122 to interact with the DMS 104 in order to monitor the current state and history of various devices 102. If the operator determines that something interesting is happening with one or more devices 102, the operator can use the DMS 104 to take various actions (e.g., analyze the history of the devices 102, compare one device 102 to another, compare one time frame to another for the same device 102) to understand what is happening and what corrective action needs to be taken with respect to the devices 102. Alternatively, instead of a human operator interacting with the DMS 104, another computer system may interact with the DMS 104 in order to identify problems (via machine learning techniques, for example) and take corrective action.

It can, however, be difficult for users to identify relevant information that is contained within stored events 124. There are at least three sources of difficulty. First, a single device 102 may produce a large amount of data, and it may be difficult or impossible for a human to visually scan all of this data at the event 124 level. Second, there may be a very large number of devices 102 (e.g., hundreds of thousands of devices 102 or more) producing events 124. Therefore, a voluminous amount of data may be collected and stored. Again, it may be difficult or impossible for users to be able to identify patterns or anomalies by just looking at events 124 when there is such a large amount of data to examine. Third, even if the user is looking at a small number of events 124 from a small number of devices 102, the events 124 may include a large number of properties 130. When events 124 include a large numbers of properties 130, there are many different possible combinations of properties 130, making it difficult to visually detect patterns in events 124.

To make it easier for users to identify and use the information that is available in the large numbers of events 124 (e.g., billions of events 124) received from devices 102, the analytics components 114 may include root-cause analysis components 138. The root-cause analysis components 138 may be configured to automatically generate human-friendly descriptions of various regions of data within the stored events 124. For example, the root-cause analysis components 138 may be configured to identify the most statistically significant patterns in a selected data region. This relieves users from having to look at large numbers of events 124 to understand what patterns most warrant their time and energy.

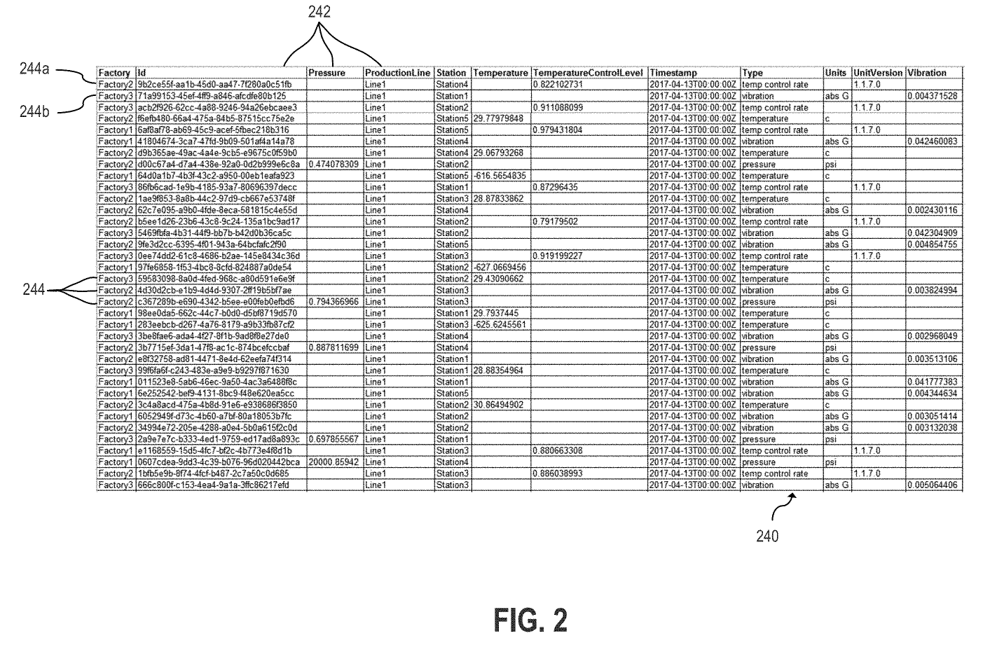

FIG. 2 illustrates an example of a table 240 that may be created to store events 124 received from devices 102. The table 240 includes a plurality of columns 242 corresponding to different properties 130 in received events 124. Each row 244 in the table 240 may correspond to a separate event 124.

Some of the fields within the table 240 do not include any values (or, stated another way, they include null values). This is because different events 124 may include different combinations of properties 130. For example, the event 124 that is represented by the first row 244a in the table 240 includes the following properties 130: Factory, Id, ProductionLine, Station, TemperatureControlLevel, Timestamp, Type, and UnitVersion. The event 124 that is represented by the second row 244b in the table 240, however, includes a different combination of properties 130: Factory, Id, ProductionLine, Station, Timestamp, Type, Units, and Vibration.

For the sake of simplicity, the table 240 shown in FIG. 2 only includes data from a few events 124, and the events 124 only include a few properties 130. In practice, however, a DMS 104 in accordance with the present disclosure may be capable of receiving and storing information about large numbers of events 124 (e.g., billions of events 124) from large numbers of devices 102 (e.g., hundreds of thousands of devices 102).

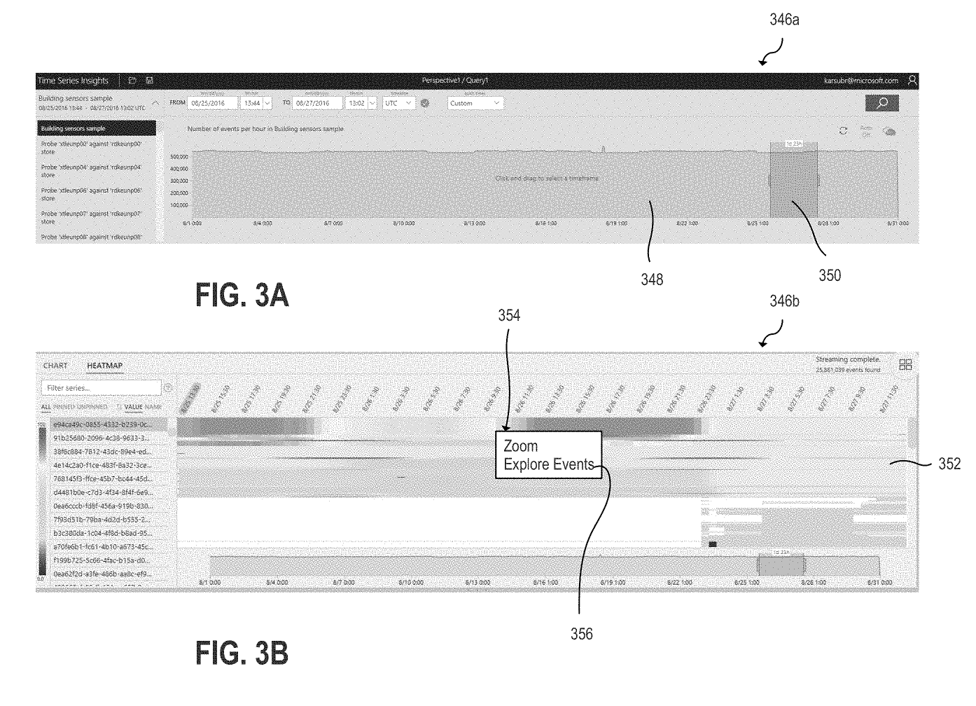

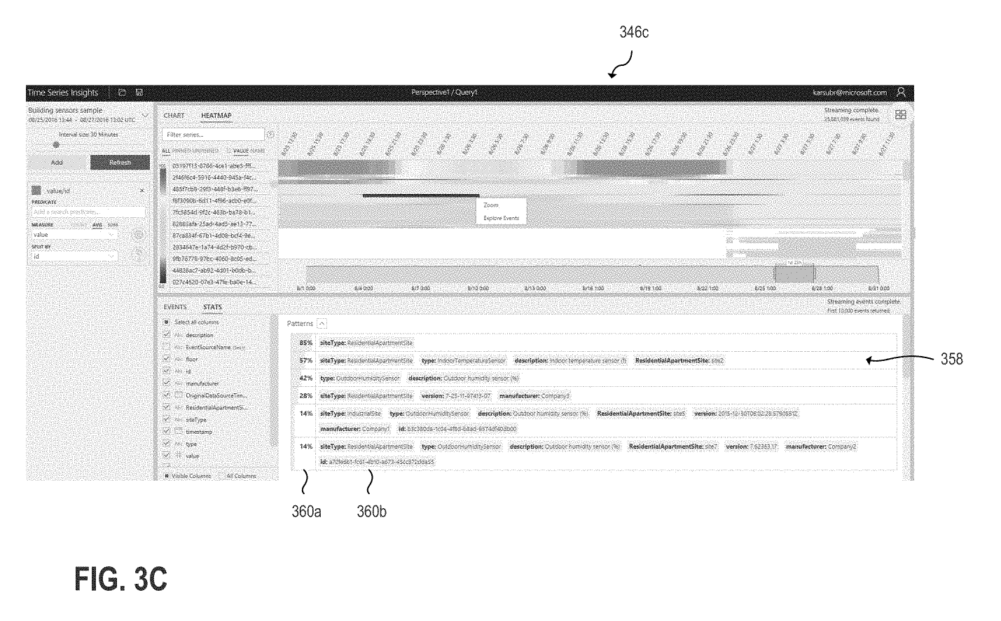

FIGS. 3A-C illustrate an example showing how a DMS 104 may be used to automatically identify patterns within a large number of stored events 124. Reference is initially made to FIG. 3A, which illustrates an example of a user interface screen 346 a (e.g., a web page) that the DMS 104 may display to a user in response to the user accessing a set of events 124 that have been stored by the DMS 104. The set of events 124 may be associated with a particular environment.

The DMS 104 may be configured to store events 124 for a limited period of time. Any events 124 that are older than the designated period of time may automatically be deleted. In the depicted example, it will be assumed that the DMS 104 stores events 124 for one month. The user interface screen 346 a includes a timeline 348 that begins at a start date (Aug. 1st) and continues until an end date (Aug. 31st).

The user may select a set of events 124 to analyze. The user may select all of the events 124 that are currently being stored by the DMS 104 for the designated environment. Alternatively, as shown in FIG. 3A, the user may select a particular timeframe 350 corresponding to a subset of the events 124. In the depicted example, the selected timeframe 350 is between Aug. 25, 2016, at 1:44 p.m. and Aug. 27, 2016, at 1:02 p.m. Thus, the user has selected the events 124 that the DMS 104 received during this timeframe 350.

FIG. 3B illustrates a user interface screen 346b that may be displayed in response to the user's selection of a particular timeframe 350 in the previous user interface screen 346a. This user interface screen 346b shows a heatmap 352 over the selected timeframe 350. The heatmap 352 is a visual representation of data in which the values of individual and specific data points are identified by allocating a specific color based on the data point value. For example, red may indicate that the data point value is high, blue may indicate that the data point value is low, and the color spectrum in between red and blue may be used to indicate the interim values of other data points.

The user may provide input that instructs the DMS 104 to identify patterns within the selected set of events 124. For example, the user may perform a right-click operation using a mouse, and in response a context menu 354 may appear. The context menu 354 may include an option 356 to “Explore Events”. The user may select this option 356 in order to cause the DMS 104 to identify patterns within the events 124 that correspond to the selected timeframe 350.

Advantageously, it is not necessary for the user to provide any additional input in order to cause the DMS 104 to identify patterns within the selected set of events 124. Once the user selects the option 356 to “Explore Events”, the DMS 104 may analyze the selected set of events 124 and identify relevant patterns automatically, without any additional user input. Thus, relatively unskilled individuals, including those who lack any training in statistical analysis or database administration, may use the DMS 104 to easily identify significant patterns within billions of events 124. This may be done with a single action, such as selecting an option 356 in a menu 354.

FIG. 3C illustrates a user interface screen 346c that may be displayed in response to the user input instructing the DMS 104 to identify patterns. This user interface screen 346c may include a list 358 of the most significant patterns that were identified within the selected set of events 124.

In the depicted example, the list 358 includes two columns 360a, 360b. In particular, the list 358 includes a first column 360a corresponding to a percentage of occurrence, and a second column 360b corresponding to properties 130 of events 124 (including their names 132 and values 134). The percentage of occurrence listed on a particular row indicates how many events 124 within the selected set of events 124 include the property 130 or combination of properties 130 that are also listed on that row. For example, the first row indicates that about 85% of the events 124 within the selected set of events 124 have a property 130 whose name 132 is “siteType” and whose value 134 is “ResidentialApartmentSite”. The second row indicates that about 57% of the events 124 within the selected set of events 124 have (i) a property 130 whose name 132 is “siteType” and whose value 134 is “ResidentialApartmentSite”, (ii) a property 130 whose name 132 is “type” and whose value 134 is “IndoorTemperatureSensor”, (iii) a property 130 whose name 132 is “description” and whose value is “Indoor temperature sensor (f)”, and (iv) a property 130 whose name 132 is “ResidentialApartmentSite” and whose value 134 is “site2”.

The percentages shown in the first column 360a of the list 358 may be determined with respect to a sample of the events 124 within the selected set of events 124. Working with a sample of the events 124 makes it possible to deliver results quickly (e.g., in near real time). Thus, it may not be the case that precisely 85% of the events 124 within the selected set of events 124 have a property 130 whose name 132 is “siteType” and whose value 134 is “ResidentialApartmentSite”. However, the fact that 85% of a sampled set of events 124 have that property 130 suggests that a high percentage of the events 124 have that property 130.

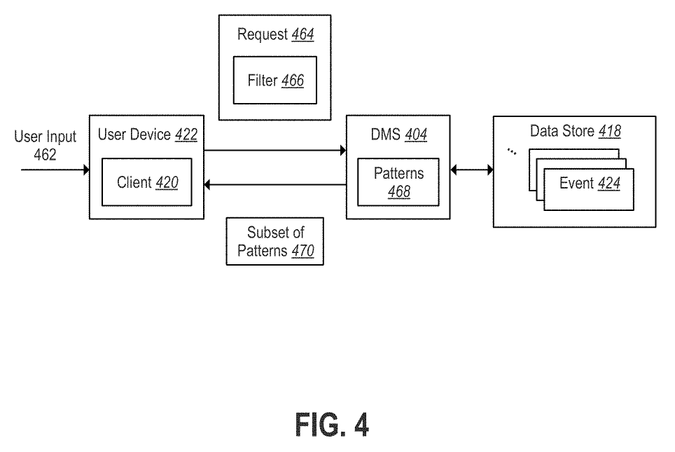

FIG. 4 illustrates an example showing how a DMS 404 may facilitate access to information contained within large numbers of stored events 424. The DMS 404 may receive and store streams of events 424 from a plurality of devices 102, via one or more event sources 110. The stored events 424 may include time series data. At some point after the DMS 404 begins receiving and storing events 424 in a data store 418, a client 420 running on a user device 422 may send a request 464 for information about the events 424 to the DMS 404. For example, the client 420 may receive user input 462 that includes an instruction to provide information about a set of events 424, and the client 420 may send the request 464 to the DMS 404 in response to the user input 462.

The request 464 may include a filter 466. The filter 466 may specify one or more criteria for the patterns 468 that are to be identified within the events 424. For example, if the user is interested in events 424 that were received during a particular time interval, the user input 462 may include an indication of a time interval for the set of events 424, and the request 464 that the client 420 sends to the DMS 404 may include a filter 466 that specifies the relevant time interval (e.g., a timeframe 350 corresponding to a subset of the events 424).

Alternatively, the filter 466 may specify one or more names 132 and values 134 of properties 130 of events 124. In this case, the patterns 468 that are returned would be limited to events 124 that have the specified names 132 and values 134 of properties 130. For example, if the user is looking for temperature patterns in a particular building, the filter 466 may specify the names 132 and values 134 of corresponding properties 130 (e.g., building==“b24” and deviceType==“temperature”).

There are many different ways for a user to provide input 462 that includes an instruction to provide information about a set of events 424. For example, the user may select an option 356 in a context menu 354, as shown in FIG. 3B. Alternatively, the user interface screen 346b may itself include an option similar to the “Explore Events” option 356 shown in FIG. 3B. As another example, the user may take some action (e.g., touching a virtual button on a touchscreen display, inputting a combination of keystrokes, providing a voice command) that may be interpreted by the client 420 as an instruction to provide information about a set of events 424. In some embodiments, the input 462 may be just a single action. Thus, it may be very simple for the user to initiate the identification of patterns within the set of events 424.

In response to the request 464, the DMS 404 may identify patterns 468 within the set of events 424. This may be done automatically, without requiring any additional user input. In other words, once the user input 462 that includes an instruction to provide information about a set of events 424 is received by the client 420 and a corresponding request 464 is sent to the DMS 404, the DMS 404 may identify patterns 468 within the set of events 424 without requiring any additional user input.

The DMS 404 may perform basket analysis in order to identify patterns 468 within the set of events 424. Basket analysis may alternatively be referred to as affinity analysis. Basket analysis is a data analysis and data mining technique that discovers co-occurrence relationships among activities performed by, or recorded about, specific entities such as devices 102. Basket analysis may utilize association rule learning, which is a rule-based machine learning method for discovering interesting relations between variables in large databases.

Performing basket analysis with respect to the events 424 that have been received by the DMS 404 may involve identifying the values 134 of properties 130 in the events 424. For example, the table 240 shown in FIG. 2 includes events 424 corresponding to twelve different properties 130. The names 132 of these properties 130 are Factory, Id, Pressure, ProductionLine, and so forth. Different values 134 (or ranges of values 134) for some or all of the different properties 130 may be identified. For example, the ProductionLine property 130 only has one value 134 in the table 240 (namely, Line1). The Station property 130, however, has five different values 134 in the table 240 (namely, Station1, Station2, Station3, Station4, and Station5). Performing basket analysis may involve identifying the percentage of occurrence for different combinations of properties 130 and their values 134. The basket analysis may be performed with respect to a sampled set of events 424.

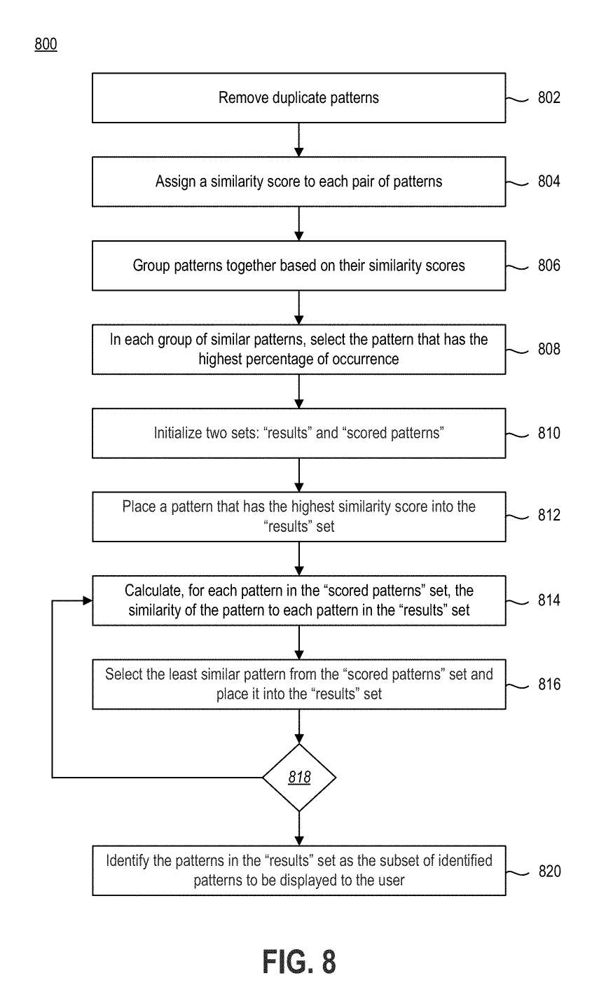

The DMS 404 may identify a very large number of patterns 468 (e.g., tens of thousands of patterns) in the set of events 424. Presenting all of these patterns to the user may not be particularly helpful. Thus, the DMS 404 may select a subset 470 of the patterns 468 to present to the user. The selected subset 470 may include those patterns 468 that are most likely to be of interest to the user. This will be discussed in greater detail below in connection with FIG. 8.

The DMS 404 may send the subset 470 of the patterns 468 to the client 420, and the client 420 may display the subset 470 of the patterns 468 to the user. In some embodiments, the selected subset 470 of patterns 468 may be displayed on a user interface screen similar to the user interface screen 346c shown in FIG. 3C. Each pattern may include a property 130 or combination of properties 130. A percentage of occurrence may be displayed next to (or within the general vicinity of) each property 130.

In the example shown in FIG. 4, the DMS 404 samples the events 424 and performs basket analysis in order to identify patterns 468 within the selected set of events 424. In an alternative embodiment, however, some or all of this processing may be performed by the client 420. For example, the DMS 404 may send the selected set of events 424 to the client 420, and the client 420 may perform sampling and basket analysis to identify patterns 468. Alternatively, the DMS 404 may sample the selected set of events 424 and send the sampled set of events 424 to the client 420, and the client 420 may perform basket analysis to identify patterns 468.

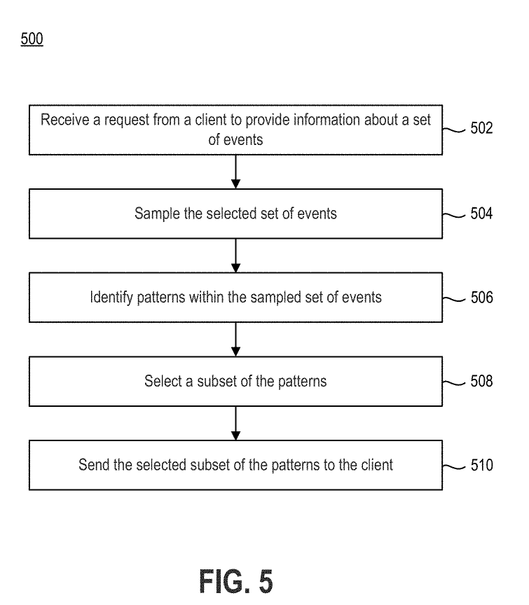

FIG. 5 is a flow diagram that illustrates an example of a method 500 for facilitating access to information contained within stored events 424. For the sake of clarity, the method 500 will be described as if it is being implemented by a DMS 404. In some embodiments, however, at least some operations of the method 500 may be implemented by a client 420 on a user device 422.

The method 500 may include receiving 502 a request 464 from a client 420 to provide information about a set of events 424. The set of events 424 may correspond to time series data received from a plurality of devices 102, via one or more event sources 110.

In response to receiving the request 464, the DMS 404 may sample 504 the selected set of events 424 and identify 506 patterns 468 within the sampled set of events 424. The DMS 404 may perform basket analysis in order to identify 506 patterns 468 within the sampled set of events 424.

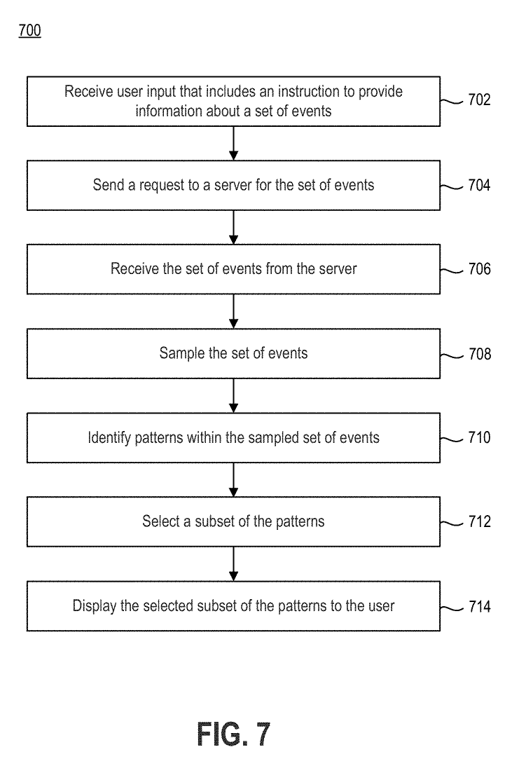

The DMS 404 may identify 506 a very large number of patterns 468 in the sampled set of events 424. The DMS 404 may select 508 a subset 470 of the patterns 468 to present to the user. This will be discussed in greater detail below in connection with FIG. 7. Once the subset 470 of the patterns 468 has been selected 508, the DMS 404 may send 510 the selected subset 470 of the patterns 468 to the client 420.

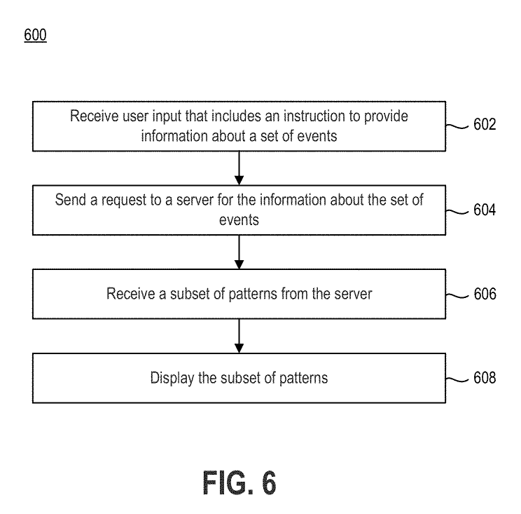

FIG. 6 is a flow diagram that illustrates another example of a method 600 for facilitating access to information contained within stored events 424. In some embodiments, the method 600 may be implemented by a client 420 (e.g., a web browser, a mobile app) running on a user device 422.

The method 600 may include receiving 602 user input 462 that includes an instruction to provide information about a set of events 424. The set of events 424 may correspond to time series data received from a plurality of devices 102, via one or more event sources 110.

In response to receiving 602 the user input 462, the client 420 may send 604 a request 464 to a server (e.g., a DMS 404) for the information about the set of events 424. As discussed above, the server may sample the set of events 424, identify patterns 468 within the sampled set of events 424, and select a subset 470 of the patterns 468. The client 420 may receive 606 the subset 470 of the patterns 468 from the server, and display 608 the subset 470 of the patterns 468 to the user.

FIG. 7 is a flow diagram that illustrates another example of a method 700 that may be performed by a client 420 in accordance with the present disclosure. The method 700 may include receiving 702 user input 462 that includes an instruction to provide information about a set of events 424. In response to receiving 702 the user input 462, the client 420 may send 704 a request 464 to a server (e.g., a DMS 404) for the set of events 424. Upon receiving 706 the set of events 424 from the server, the client 420 may sample 708 the set of events 424, identify 710 patterns 468 within the sampled set of events 424, and select 712 a subset 470 of the patterns 468. The selected subset 470 of the patterns 468 may then be displayed 714 to the user.

FIG. 8 illustrates an example of a method 800 showing how a subset 470 of identified patterns 468 may be selected. The method 800 may include removing 802 duplicate patterns 468. As noted above, a very large number of patterns 468 (e.g., tens of thousands of patterns) may be identified within a sampled set of events 424. Some of these patterns 468 may be duplicates of one another. This may occur, for example, if the basket analysis algorithm does not take into consideration the “empty” symbols of the different data types that may be used. Duplicate patterns 468 may be removed 802 irrespective of their percentage of occurrence.

To identify N diverse patterns 468, a similarity score may be assigned 804 to each pair of patterns 468. The similarity score for a particular pair of patterns 468 may indicate how similar those patterns 468 are. For example, a high similarity score may indicate that two patterns 468 are highly similar to one another, and vice versa. The similarity score for a pair of patterns 468 may be determined by comparing the patterns 468 (e.g., via character matching).

Patterns 468 may be grouped 806 together based on their similarity scores. For example, any patterns 468 that have a similarity score above a particular threshold may be grouped together. Thus, various groups of similar patterns 468 may be created. In each group of similar patterns 468, the pattern 468 that has the highest percentage of occurrence may be selected 808, and other patterns 468 within that group may be discarded. (The percentage of occurrence of a pattern 468 within a set of events 424 was discussed above in connection with FIG. 3C.)

The method 800 may also include initializing 810 two sets: a “results” set and a “scored patterns” set. The “results” set is intended to include the patterns 468 that will be selected and displayed to the user. The “results” set may initially be empty. The “scored patterns” set may initially include all of the patterns 468 that remain (after duplicate patterns 468 are removed 802 and after one pattern 468 is selected 808 from each group of similar patterns 468).

A pattern 468 having the highest similarity score may initially be placed 812 into the “results” set. The method 800 may then include calculating 814, for each pattern 468 in the “scored patterns” set, the similarity of the pattern 468 to each pattern 468 in the “results” set (which may initially be just one pattern 468). The least similar pattern 468 from the “scored patterns” set may then be selected 816 and placed into the “results” set.

A determination may then be made 818 about whether enough patterns 468 have been selected to display to the user. For example, if it is desirable for N patterns 468 to be displayed to the user, a determination may be made 818 about whether there are N patterns 468 in the “results” set. If not, then the method 800 may return to the operation of calculating 814, for each pattern 468 in the “scored patterns” set, the similarity of the pattern 468 to each pattern 468 in the “results” set. The method 800 may then proceed as described above. When it is determined 818 that there are N patterns 468 in the “results” set, then the patterns 468 in the “results” set may be identified 820 as the subset 470 of identified patterns 468 to be displayed to the user.

In accordance with the method 800 shown in FIG. 8, the subset 470 of the patterns 468 may be selected based at least partially on percentage of occurrence within the set of events 424 and also at least partially based on pattern similarity. Thus, patterns 468 may be selected that are both significant (i.e., having a high percentage of occurrence within the set of events 424) and also not very similar to one another. Consequently, a significant and diverse set of patterns 468 may be presented to the user.

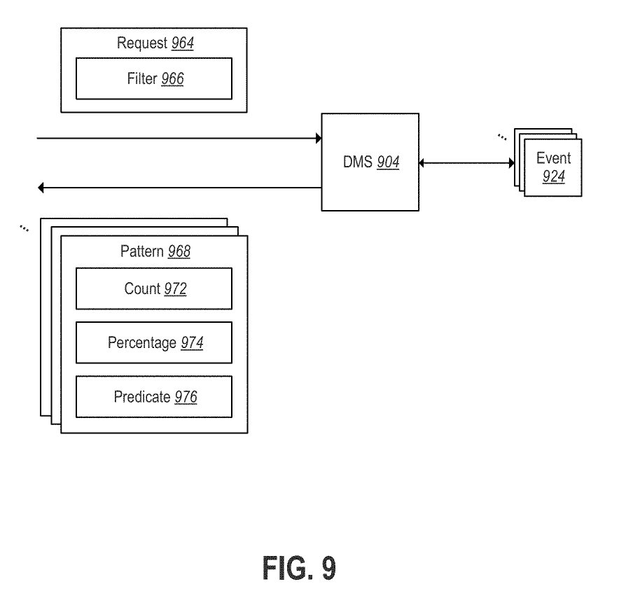

FIG. 9 illustrates characteristics of patterns 968 in accordance with some embodiments. In response to a request 964 to identify patterns 968, a DMS 904 may identify and return a set of patterns 968 that includes the following properties: a count 972, a percentage 974, and a predicate 976. The count 972 indicates the number of events 924 that match the pattern 968. The percentage 974 indicates the percentage of events 924 that satisfy the criteria specified in the filter 966. The predicate 976 represents the pattern 968 as a logical expression.

The following is an example of a set of patterns 968 that may be returned in response to a request 964 to identify patterns 968.

{

“patterns”:[

{“count”:9194,“percentage”:91.94,“predicate”:{“and”:[{“eq”:{“lef

t”:{“property”:“siteType”,“type”:“String”},“right”:“ResidentialApartmen
tSite”}}]}},

{“count”:8433,“percentage”:84.33,“predicate”:{“and”:[{“eq”:{“lef

t”:{“property”:“type”,“type”:“String”},“right”:“IndoorTemperatureSensor
”}},{“eq”:{“left”:{“property”:“description”,“type”:“String”},“right”:“I
ndoor temperature sensor (f)”}}]}},

{“count”:2077,“percentage”:20.77,“predicate”:{“and”:[{“eq”:{“lef

t”:{“property”:“manufacturer”,“type”:“String”},“right”:“Company5”}}]}},

{“count”:1482,“percentage”:14.82,“predicate”:{“and”:[{“eq”:{“lef

t”:{“property”:“manufacturer”,“type”:“String”},“right”:“Company6”}}]}},

{“count”:1463,“percentage”:14.63,“predicate”:{“and”:[{“eq”:{“lef

t”:{“property”:“manufacturer”,“type”:“String”},“right”:“Company1”}}]}},

{“count”:1280,“percentage”:12.8,“predicate”:{“and”:[{“eq”:{“left

”:{“property”:“manufacturer”,“type”:“String”},“right”:“Company2”}}]}}

]

}

In the above example, the predicate 976 of each pattern 968 is structured as an expression tree. However, it is not necessary for the predicate 976 to be structured in this way. Any formal language (e.g., SQL, C#, C++) may be used for the syntax of the predicate 976.

There may be several advantages to expressing a pattern 968 as a predicate 976, or logical expression, instead of expressing the pattern 968 in a different way (e.g., as a list of name-value pairs). For example, the predicate 976 may easily be used “as is” (i.e., in the form in which the predicate 976 is expressed in the pattern 968) as part of a query that targets events 924 that are described by the pattern 968. In addition, expressing the pattern 968 as a predicate 976 makes it possible to identify and return patterns 968 that are more complex than combinations of names 132 and values 134 of properties 130. For example, patterns 968 may be identified and returned that use logical expressions other than equality comparison and logical AND. Some examples of such patterns 968 include:

P1 IN (v1, v2, v3) and P2!=v4

P1>v1 and P2<v2

In the above examples, “P” refers to the name 132 of a property 130 of an event 124, and “v” refers to the value 134 of the property 130.

A DMS 104 with root-cause analysis components 138 as disclosed herein may be helpful for post-mortem investigations into historical data. Some users may have mechanisms in place that provide alerts when failures occur. A DMS 104 with root-cause analysis components 138 may be used as a complementary investigative tool to understand the context of an alert. The DMS 104 may be used to look back during a postmortem analysis for additional clues to help mitigate and prevent similar failures from occurring in the future. Advantageously, it is not necessary for the user to understand what caused a particular set of failures in order to use the DMS 104 to analyze data related to the failures. Instead, the user may simply select some interesting region of data relating to the failures (e.g., sensors with unusually high temperature values, sensors that have failed). The DMS 104 may then enable a user to identify what is common across the failures.

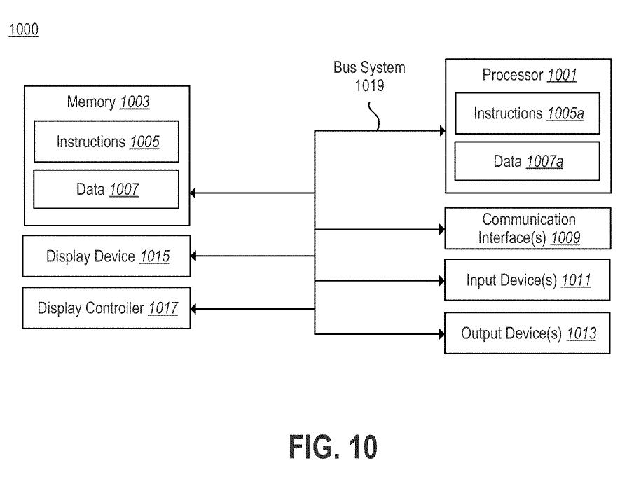

FIG. 10 illustrates certain components that may be included within a computer system 1000. One or more computer systems 1000 may be used to implement a DMS 104 as disclosed herein. Also, a user device 122 as disclosed herein may include one or more computer systems 1000.

The computer system 1000 includes a processor 1001. The processor 1001 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1001 may be referred to as a central processing unit (CPU). Although just a single processor 1001 is shown in the computer system 1000 of FIG. 10, in an alternative configuration, a combination of processors (e.g., an ARM and DSP) could be used.

The computer system 1000 also includes memory 1003. The memory 1003 may be any electronic component capable of storing electronic information. For example, the memory 1003 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1005 and data 1007 may be stored in the memory 1003. The instructions 1005 may be executable by the processor 1001 to implement some or all of the methods disclosed herein. Executing the instructions 1005 may involve the use of the data 1007 that is stored in the memory 1003. When the processor 1001 executes the instructions 1005, various portions of the instructions 1005a may be loaded onto the processor 1001, and various pieces of data 1007 a may be loaded onto the processor 1001.

Any of the various examples of modules and components described herein (such as the ingestion and storage components 112, the analytics components 114, the visualization components 116, and the root-cause analysis components 138) may be implemented, partially or wholly, as instructions 1005 stored in memory 1003 and executed by the processor 1001. Any of the various examples of data described herein (such as the events 124 and the table 340) may be among the data 1007 that is stored in memory 1003 and used during execution of the instructions 1005 by the processor 1001.

A computer system 1000 may also include one or more communication interfaces 1009 for communicating with other electronic devices. The communication interfaces 1009 may be based on wired communication technology, wireless communication technology, or both. Some examples of communication interfaces 1009 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1000 may also include one or more input devices 1011 and one or more output devices 1013. Some examples of input devices 1011 include a keyboard, mouse, microphone, remote control device, button, joystick, trackball, touchpad, and lightpen. Some examples of output devices 1013 include a speaker, printer, etc. One specific type of output device that is typically included in a computer system is a display device 1015. Display devices 1015 used with embodiments disclosed herein may utilize any suitable image projection technology, such as liquid crystal display (LCD), light-emitting diode (LED), gas plasma, electroluminescence, or the like. A display controller 1017 may also be provided, for converting data 1007 stored in the memory 1003 into text, graphics, and/or moving images (as appropriate) shown on the display device 1015.

The various components of the computer system 1000 may be coupled together by one or more buses, which may include a power bus, a control signal bus, a status signal bus, a data bus, etc. For the sake of clarity, the various buses are illustrated in FIG. 10 as a bus system 1019.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for facilitating access to information contained within stored events, the method being implemented by a computer system comprising one or more processors, the method comprising:
receiving a request to provide information about a set of events, the set of events corresponding to time series data from a plurality of devices;
identifying patterns within the set of events in response to the request, wherein identifying the patterns within the set of events comprises performing basket analysis; and
selecting a subset of the patterns based at least partially on percentage of occurrence within the set of events and pattern similarity.

2. The method of claim 1, wherein:
each pattern comprises a property or a combination of properties; and
each pattern is associated with the percentage of occurrence of the property or the combination of properties within the set of events.

3. The method of claim 2, wherein each pattern further comprises a predicate that represents the pattern as a logical expression.

4. The method of claim 1, further comprising sampling the set of events, wherein the patterns are identified within a sampled set of events.

5. The method of claim 1, wherein selecting the subset of the patterns comprises removing duplicate patterns.

6. The method of claim 1, wherein selecting the subset of the patterns comprises assigning a similarity score to each pair of patterns.

7. The method of claim 1, wherein the computer system automatically identifies the patterns within the set of events and automatically selects the subset of the patterns in response to the request.

8. The method of claim 1, wherein the request is received from a client, and further comprising sending the subset of the patterns to the client.

9. The method of claim 1, wherein the request is received via user input, and further comprising displaying the subset of the patterns.

10. A computer system for facilitating access to information contained within stored events, comprising:
one or more processors; and
memory comprising instructions that are executable by the one or more processors to perform operations comprising:
receiving a request to provide information about a set of events, the set of events corresponding to time series data from a plurality of devices;
identifying patterns within the set of events in response to the request, wherein identifying the patterns within the set of events comprises performing basket analysis; and
selecting a subset of the patterns based at least partially on percentage of occurrence within the set of events and pattern similarity.

11. The computer system of claim 10, wherein:
each pattern comprises a property or a combination of properties; and
each pattern is associated with the percentage of occurrence of the property or the combination of properties within the set of events.

12. The computer system of claim 10, wherein the operations further comprise sampling the set of events, and wherein the patterns are identified within a sampled set of events.

13. The computer system of claim 10, wherein selecting the subset of the patterns comprises removing duplicate patterns.

14. The computer system of claim 10, wherein selecting the subset of the patterns comprises assigning a similarity score to each pair of patterns.

15. The computer system of claim 10, wherein the computer system automatically identifies the patterns within the set of events and automatically selects the subset of the patterns in response to the request.

16. The computer system of claim 10, wherein the request is received from a client, and wherein the operations further comprise sending the subset of the patterns to the client.

17. The computer system of claim 10, wherein the request is received via user input, and wherein the operations further comprise displaying the subset of the patterns.

18. The computer system of claim 10, wherein each pattern comprises a predicate that represents the pattern as a logical expression.

19. A method for facilitating access to information contained within stored events, the method being implemented by a computer system comprising one or more processors, the method comprising:
receiving a request from a client to provide information about a set of events, the set of events corresponding to time series data from a plurality of devices;
sampling the set of events, thereby producing a sampled set of events;
identifying patterns within the sampled set of events;
selecting a subset of the patterns based at least partially on percentage of occurrence within the set of events and pattern similarity; and
sending the subset of the patterns to the client.

20. The method of claim 19, wherein selecting the subset of the patterns comprises:
removing duplicate patterns; and
assigning a similarity score to each pair of patterns.
